(19) United States
(12) Patent Application Publication
(10) Pub. No.: US 2011/0067200 A1
(43) Pub. Date: Mar. 24, 2011

(54) Cable Grommet Guide for Bicycles

(75) Inventor: José Luis BEISTEGUI CHIRAPOZU, Vitoria-Gasteiz (ES)

(73) Assignee: BEISTEGUI HERMANOS, S.L., VITORIA-GASTEIZ (ES)

(21) Appl. No.: 12/719,101

(22) Filed: Mar. 8, 2010

(30) Foreign Application Priority Data
Sep. 23, 2009 (ES) U200930449

(51) Int. Cl. F16L 5/00

(52) U.S. Cl. 16/2.1

(57) ABSTRACT

The invention relates to a cable grommet guide for bicycles comprising a body (10) with parallel channels (12) for the passage of cables, wherein the channels are communicated allowing the crossing of the cables at different levels without friction between them.

### FIELD OF THE INVENTION

The present invention relates to gear cable guides for bicycles, generally arranged to fasten or orient gear shift cables in bicycles, which are responsible for transmission from the gear levers, for the purpose of adjusting the pedaling to the physical geography of the terrain to be traveled. The present invention specifically relates to a cable grommet guide for bicycles.

### BACKGROUND OF THE INVENTION

Traditional cable grommet guides which transmit the position of the front and rear gears place the mentioned cables parallel to one another under the diagonal tube and the bottom bracket towards the rear part of the bicycle, such that the cable transmitting the action of the right gear lever is arranged to the right of the steering tube and along the right side of the diagonal tube until reaching the rear gear under the bottom bracket; in contrast, the cable of the gear lever arranged to the left is led to or positioned to the left of the steering tube and along the left side of the diagonal tube until the chain deflector.

Due to current guiding of the cables through the inner part of the handle bar, the curves or radii arranged in both gears, from the gear levers on their respective sides, force their action against the tubes of the bicycle, causing forced displacements, with the subsequent surface damage to the paint on the steering tube.

### SUMMARY OF THE INVENTION

The present invention relates to a cable grommet guide for bicycles, preferably road bicycles, of the type comprising a body with parallel channels for the passage of cables which transmit the actions in the front and rear gears of a bicycle, the channels of which are communicated allowing the crossing of the cables at different levels without friction between them.

### BRIEF DESCRIPTION OF THE DRAWINGS

The present invention will be better understood in reference to the following drawings showing preferred embodiments of the invention, provided by way of example, which should not be interpreted as being limiting of the invention in any manner.

FIG. 1 shows a top perspective view of the cable grommet guide for bicycles according to a preferred embodiment of the present invention.

FIG. 2 shows a bottom perspective view of the cable grommet guide for bicycles according to FIG. 1.

FIG. 3 shows a top perspective view of the cover of the cable grommet guide for bicycles according to a preferred embodiment of the present invention.

FIG. 4 shows a bottom perspective view of the cover of the cable grommet guide for bicycles according to FIG. 3.

FIG. 5 shows a top perspective view of the cable grommet guide for bicycles with the cover assembled according to a preferred embodiment of the present invention.

FIG. 6 shows a bottom perspective view of the cable grommet guide for bicycles with the cover assembled according to FIG. 5.

### DETAILED DESCRIPTION OF THE PREFERRED EMBODIMENTS

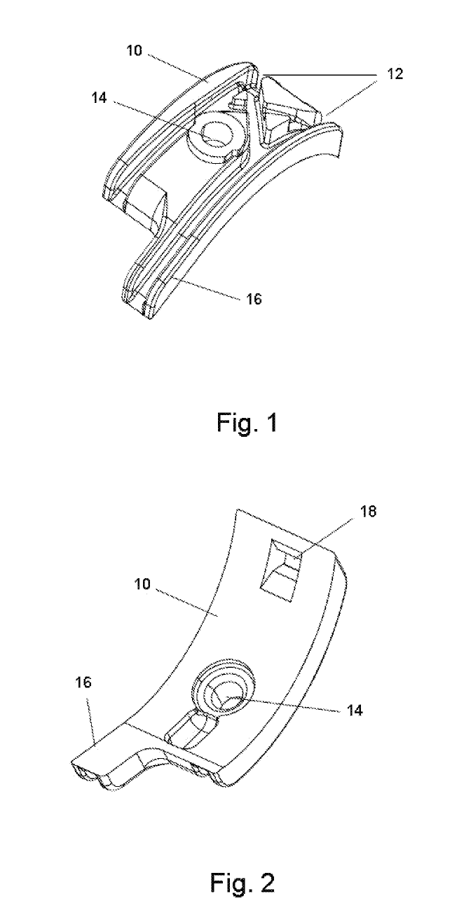

FIG. 1 shows a cable grommet guide for bicycles according to a preferred embodiment comprising a body 10 with parallel channels 12 for the passage of cables in which the channels are communicated allowing the crossing of the cables at different levels without friction between them. FIG. 1 shows the body 10 with a certain curve for being adapted to the frame of the bicycle, having a central hole 14 for the passage of a fixing element for the fixing to the frame of the bicycle and having at least one projection 16 to prevent the friction of the cables at the exit of the guide. Although in this preferred embodiment the body 10 is depicted with a certain curve, it may not have such curve in other embodiments of the invention.

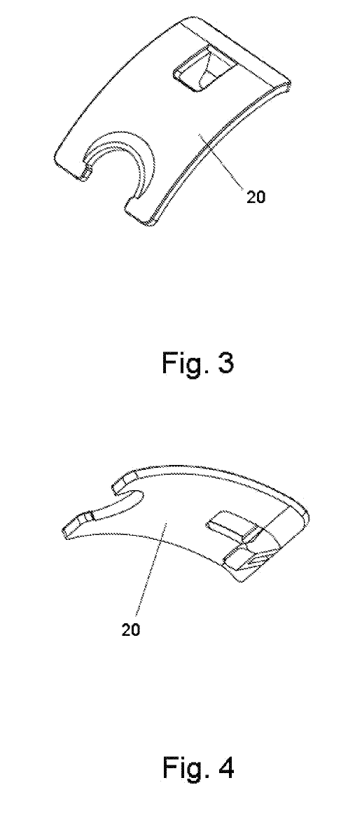

In FIG. 2, it can be seen that the body 10 has in addition to the central hole 14 a top hole 18, with a quadrangular configuration, at one of its ends for the fixing of the cover 20 (shown in FIGS. 3 and 4) to the body 10 by male-female fixation.

The cover 20 serves to conceal and protect the cables running in the channels 12 against becoming dirty or the accumulation of dust. This cover 20 is fixed to the guide by means of a screw 22 which is screwed in a central hole 14 made between the two channels 12.

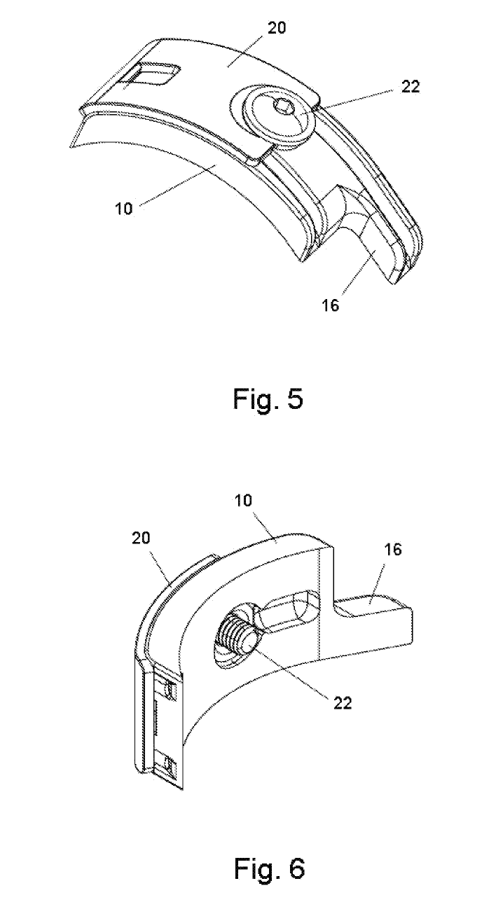

In FIGS. 5 and 6, the body 10 and the cover 20 assembled such that the body 10 is fixed to a frame of bicycle by means of a screw 22 can be observed.

The mentioned cable grommet guide is preferably placed in the lower area of the body of the bottom bracket in order to channel the cables which transmit the switching of gears to the gear and to the deflector.

According to a preferred aspect of the present invention, the cables pass crossing one another within the channels, i.e., the position of both cables is modified such that the cable of the right gear lever or control is placed on the left side of the steering tube and, accordingly, the cable of the gear lever placed on the left side is placed on the opposite side (the right side) of the steering tube. The transmission of the movement through the cables is therefore more fluid and less forced. This means that the cables cross one another in front of the steering tube with a broader radius.

However, given that the present guide also incorporates parallel channels, the cables can pass in the traditional position, i.e., parallel to one another within the channels.

Although the present invention has been described more in detail in reference to some preferred embodiments thereof, other variations will be obvious for persons skilled in the art, such as the fact that the body may not have a curve for being adapted to other parts of the bicycle, it can be fixed by means of other fastening systems, for example, by means of adhesive. It is sought that such variations are covered by the scope of the present invention, defined by the following claims.

1. Cable grommet guide for bicycles, comprising a body (10) with parallel channels (12) for the passage of cables, characterized in that the channels are communicated allowing the crossing of the cables at different levels without friction between them.

2. Cable grommet guide according to claim 1, characterized in that the body (10) has a central hole (14) for the passage of a fixing element for the fixing to the frame of the bicycle.

3. Cable grommet guide according to claim 2, characterized in that said fixing element is a screw (22).

4. Cable grommet guide according to claim 1, characterized in that the body (10) has at least one projection (16) to prevent the friction of the cables at the exit of the guide.

5. Cable grommet guide according to claim 1, characterized in that the guide has a cover (20) which conceals and protects the cables running in the channels of the body (10).

6. Cable grommet guide according to claim 5, characterized in that the cover (20) is fixed to the body (10) by male-female fixation.

7. Cable grommet guide according to claim 1, characterized in that the cables pass parallel to one another within the channels (12).

8. Cable grommet guide according to claim 1, characterized in that the cables pass crossing one another within the channels (12).
